(19) United States
(12) Patent Application Publication
(10) Pub. No.: US 2026/0086592 A1
(43) Pub. Date: Mar. 26, 2026

(54) TEMPERATURE DRIFT COMPENSATION FOR GENERATING A REFERENCE VOLTAGE

(71) Applicant: TEXAS INSTRUMENTS INCORPORATED, Dallas, TX (US)

(72) Inventors: Tallam Vishwanath, Bangalore (IN); Vinod Menezes, Bangalore (IN); Subramanian Narayan, Bangalore (IN)

(21) Appl. No.: 19/066,930

(22) Filed: Feb. 28, 2025

(30) Foreign Application Priority Data
Sep. 20, 2024 (IN) 202441071162

(51) Int. Cl. G05F 3/18

(52) U.S. Cl. CPC G05F 3/18

(57) ABSTRACT

A device includes a heating element to generate heat for a die and maintain its temperature. The device includes a Buried Zener (BZ) diode positioned at a first distance from the heating element and a sensing element positioned at a second distance to the BZ diode to sense a temperature of the die at the second distance from the BZ diode for controlling the heat. A distance between a position of the BZ diode and a position of the sensing element is less than a given threshold. Transistors coupled to the BZ diode output a reference voltage with an offset voltage. The transistors are positioned at a third distance (greater than the first distance) from the heating element thereby positioning the BZ diode between the heating element and the transistors. A voltage compensating unit is positioned between the BZ diode and the heating element to reduce the offset voltage.

### RELATED APPLICATIONS

The instant application is a nonprovisional patent application that claims the benefit and priority to the Indian Application Number 202441071162, filed on Sep. 20, 2024, which is incorporated herein by reference in its entirety.

### BACKGROUND

High precision voltage references have been used in a wide array of applications. For example, many data acquisition systems, medical equipment, sensor conditioning circuits, battery monitoring systems, high resolution analog to digital converters, calibration equipment, and precision instrumentation, are only a few applications that rely on high precision voltage reference. To achieve low temperature drift, some conventional systems have used a heater (e.g., die heater) to regulate a desired temperature that is independent of ambient temperature. Conventionally, temperature drift compensation schemes have been used, for example in Oven Controlled Voltage References (OCVR), to address a drift in voltage when temperature changes and assume that the temperature across the entire die is the same (e.g., uniform junction temperature, heater temperature, ambient temperature, etc.). In OCVR, a small portion of the die is regulated to a desired temperature independent of the ambient temperature.

Some high precision voltage reference circuitries have used a Buried Zener diode due to its lower stress sensitivity, low noise, low long-term drift, solder shift, thermal hysteresis, etc. However, Buried Zener diodes use large die areas, resulting in thermal gradient across the die. As such, assuming that the temperature across the entire die (e.g., in OCVR) is the same is not true and using a small portion of the die to regulate the entire die is not effective when a Buried Zener diode is used because the Buried Zener diode uses a large area of the die, thereby resulting in voltage drift that goes unaddressed by the temperature drift compensation schemes.

### SUMMARY

In an example, a device includes a heating element configured to generate heat for a die and to maintain a temperature for the die. The device further includes a Buried Zener diode positioned at a first distance from the heating element. Current flows in the Buried Zener diode in response to the Buried Zener diode reaching a Zener voltage. The device also includes a sensing element, e.g., a temperature sensor, positioned at a second distance, e.g., adjacent, to the Buried Zener diode. The second distance is smaller than the first distance. A distance between a position of the Buried Zener and a position of the sensing element is less than a given threshold. The sensing element is configured to sense a temperature of the die at the second distance from the Buried Zener diode and to control a heat generated by the heating element in response thereto. The device further includes at least one or more transistors associated with the Buried Zener diode configured to output a first voltage reference. The first voltage reference is a reference voltage with an offset voltage. The at least one or more transistors are positioned at a third distance from the heating element thereby positioning the Buried Zener diode between the heating element and the one or more transistors. The third distance is greater than the first distance. The offset results from a change in ambient temperature between a location of the at least one or more transistors and a location of the sensing element. The device further includes a voltage compensating unit positioned between the sensing element and the heating element, wherein the voltage compensating unit is configured to reduce the offset voltage.

In one nonlimiting example, the change in ambient temperature seen by the at least one or more transistors is substantially opposite to a change in ambient temperature seen by the voltage compensating unit. According to one nonlimiting example, the voltage compensating unit includes a transistor coupled to a plurality of resistors, wherein the plurality of resistors is programmable to adjust a resistance value. In one nonlimiting example, resistors of the plurality of resistors are parallel to one another and wherein each resistor of the plurality of resistors is associated with a respective transistor that couples the each resistor with other resistors of the plurality of resistors when turned on. According to one nonlimiting example, the change in ambient temperature seen by the transistor coupled to the plurality of resistors is complementary to absolute temperature (CTAT). The change in ambient temperature seen by the at least one or more transistors is proportional to absolute temperature (PTAT) according to one example. In one nonlimiting example, the heating element is a heater ring that substantially enclose the Buried Zener diode, the sensing element, the at least one or more transistors, and the voltage compensating unit. According to one nonlimiting example, a surface of the die occupied by the Buried Zener diode creates a thermal gradient across the die, and wherein the offset voltage results from the at least one or more transistors being at a different thermal gradient from the Buried Zener diode.

A device includes a heating element configured to generate heat for a die and to maintain a temperature for the die. The device also includes a Buried Zener diode positioned at a first distance from the heating element. According to one nonlimiting example, a device includes a sensing element, e.g., a temperature sensor, positioned, e.g., adjacent to, at a second distance to the Buried Zener diode. The second distance is smaller than the first distance. A distance between a position of the Buried Zener and a position of the sensing element is less than a given threshold. The sensing element is configured to sense a temperature of the die at the second distance from the Buried Zener diode and to control a heat generated by the heating element in response thereto. In one nonlimiting example, the device includes at least one or more transistors coupled to the Buried Zener diode configured to output a first voltage reference. The first voltage reference is a reference voltage with an offset voltage. According to one nonlimiting example, the at least one or more transistors are positioned at a third distance from the heating element thereby positioning the Buried Zener diode between the heating element and the one or more transistors. The third distance is greater than the first distance in one example. The device may also include a voltage compensating unit positioned between the Buried Zener diode and the heating element. The voltage compensating unit is configured to reduce the offset voltage.

In one nonlimiting example, a change in ambient temperature seen by the at least one or more transistors is substantially opposite to a change in ambient temperature seen by the voltage compensating unit. According to one nonlimiting example, the voltage compensating unit comprises a transistor coupled to a plurality of resistors, wherein the plurality of resistors is programmable to adjust a resistance value. In some examples, resistors of the plurality of resistors are parallel to one another and wherein each resistor of the plurality of resistors is associated with a respective transistor that couples the each resistor with other resistors of the plurality of resistors when turned on. In one nonlimiting example, a change in ambient temperature seen by the transistor coupled to the plurality of resistors is complementary to absolute temperature (CTAT). In yet one nonlimiting example, a change in ambient temperature seen by the at least one or more transistors is proportional to absolute temperature (PTAT). In one example, the heating element is a heater ring that substantially enclose the Buried Zener diode, the sensing element, the at least one or more transistors, and the voltage compensating unit. According to one nonlimiting example, a surface of the die occupied by the Buried Zener diode creates a thermal gradient across the die, and wherein the offset voltage results from the at least one or more transistors being at a different thermal gradient from the Buried Zener diode.

### BRIEF DESCRIPTION OF THE DRAWINGS

FIG. 1 is a schematic diagram of a device that includes a temperature drift compensation scheme, in an example.

FIG. 2 is a schematic diagram of a circuit associated with temperature drift compensation scheme, in an example.

FIG. 3 is a schematic diagram of a programmable voltage compensating unit, in an example.

FIG. 4A shows the expected temperature drift after applying the voltage compensating unit in an example.

FIG. 4B shows a simulation result for temperature drift with respect to trim code, in an example.

FIG. 4C shows performance for a number of different temperature coefficients.

FIG. 5 is a schematic diagram of the device including a voltage compensating unit of FIG. 1 and positioning of the voltage compensating unit, in an example.

### DETAILED DESCRIPTION

The same reference numbers or other reference designators are used in the drawings to designate the same or similar (either by function and/or structure) features. Before various examples are described in greater detail, it should be understood that the examples are not limiting, as elements in such examples may vary. It should likewise be understood that a particular example described and/or illustrated herein has elements which may be readily separated from the particular example and optionally combined with any of several other examples or substituted for elements in any of several other examples described herein. It should also be understood that the terminology used herein is for the purpose of describing certain concepts, and the terminology is not intended to be limiting. Unless defined otherwise, all technical and scientific terms used herein have the same meaning as commonly understood in the art to which the examples pertain.

As described above, thermal gradient is created across a die that uses Buried Zener diodes due to a large area of the die being used by Buried Zener diodes. As such, use of temperature drift compensation schemes (that assume the temperature across the entire die is the same) to address a drift in voltage when temperature changes (e.g., ambient temperature) is ineffective in addressing a drift in voltage due to the thermal gradient. In other words, using a small portion of the die where the sensor is positioned to sense the temperature to regulate the entire die is neither effective nor precise enough in high precision applications. Some high precision application may include but are not limited to data acquisition systems, medical equipment, sensor conditioning circuits, battery monitoring systems, high resolution analog to digital converters, calibration equipment, X-rays, multimeters, and precision instrumentation (such as digital multimeter, tester measurement, etc.). Accordingly, a temperature drift compensation scheme that compensates for a drift and by considering the thermal gradient is desired.

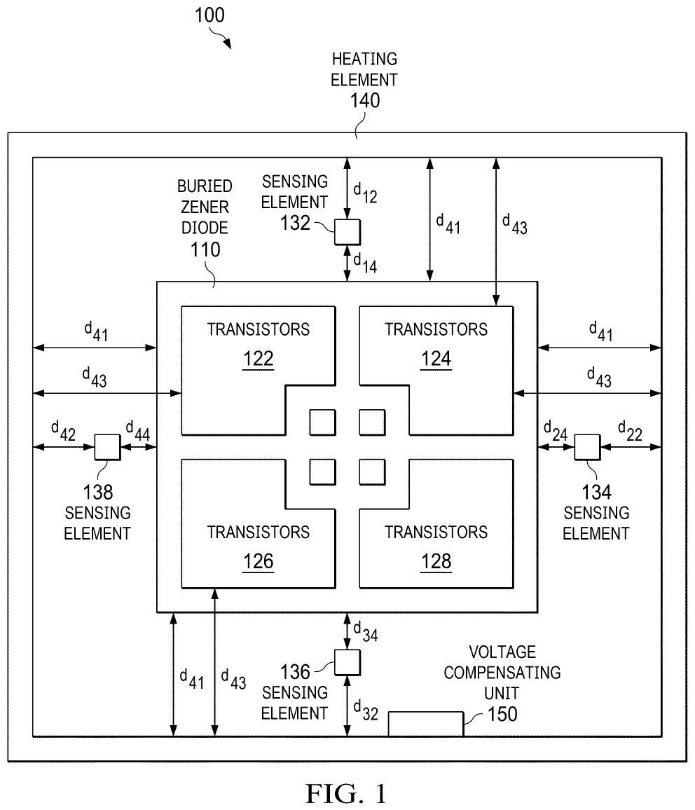

FIG. 1 is a schematic diagram of a device 100 including temperature drift compensation scheme, in an example. The device 100 may be a die that includes a heating element 140, a plurality of sensing elements 132-138, a Buried Zener diode 110, transistors 122-128, and a voltage compensating unit 150. The heating element 140 may be ring-shaped and may encompass (circumferentially) the plurality of sensing elements 132-138, the Buried Zener diode 110, the transistors 122-128, and the voltage compensating unit 150. The Buried Zener diode 110 may encompass the transistors 122-128, and the sensing elements 132-138 may be positioned between the Buried Zener diode 110 and the heating element 140.

The heating element 140 is configured to generate heat in order to maintain the temperature of the die at a constant temperature. For example, the heating element 140 may generate more heat when the ambient temperature drops and may generate less heat when the ambient temperature increases. The heating element 140 may be a heater ring that generates heat in response to a change in ambient temperature.

In one nonlimiting example, the plurality of sensing elements 132-138, e.g., temperature sensor, is used to sense a temperature of the die. In this nonlimiting example, four sensing elements are shown for illustrative purposes and should not be construed as limiting the scope of the examples. For example, one sensing element may be used or more than four sensing elements may be used. In implementations where more than one sensing element is used, e.g., sensing elements 132-138, an average of the temperature sensed may be used to determine the temperature of the die. In this example, the sensing element 138 is configured to sense the temperature of the die at a position of the sensing element 138. Similarly, sensing elements 132-136 each sense the temperature of the die at their respective position. The sensed temperature may be averaged and if the sensed temperature (e.g., average temperature) is lower than a particular temperature (e.g., in response to the ambient temperature falling), then the heating element 140 may generate heat to maintain the temperature at the particular temperature. Similarly, if the sensed temperature is higher than a particular temperature (e.g., in response to the ambient temperature increasing), then the heating element 140 is turned off to lower the temperature and maintain the temperature of the die at the particular temperature.

The Buried Zener diode 110 and the transistors 122-128 associated therewith are used to output a voltage reference, but as described above, the voltage reference includes an offset voltage resulting from the thermal gradient across the die (a change in ambient temperature between a location of the transistors 122-128 and a location of the sensing elements 132-138). In one nonlimiting example, current flows in the Buried Zener diode 110 in response to the Buried Zener diode 110 reaching a Zener voltage. The transistors 122-128 output a reference voltage (that includes an offset voltage) to address a drift in voltage when the ambient temperature changes. In one nonlimiting example, the change in ambient temperature experienced by the transistors 122-128 is PTAT.

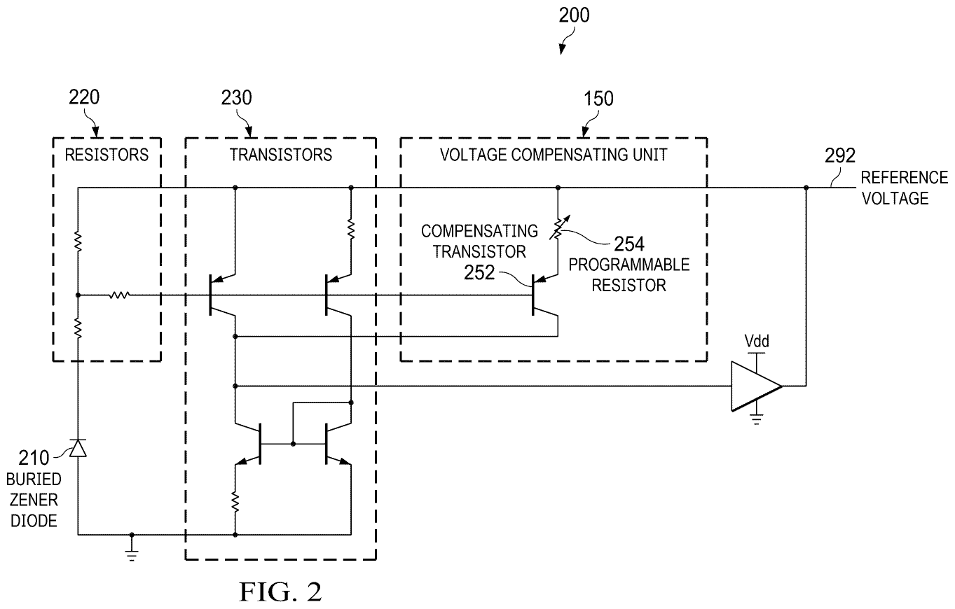

The reference voltage that is output from the transistors 122-128 includes an offset voltage due to the thermal gradient (different temperature experienced by the transistors 122-128 due to the large area of Buried Zener diode 110 compared to that of the sensing elements 132-138). Accordingly, the voltage compensating unit 150 (described in greater detail with respect to FIG. 2) positioned on the opposite side of the Buried Zener diode 110 with respect to the transistors 122-128 is used to remove the offset voltage (or to reduce the amount of offset voltage). For example, if the offset voltage by the transistors 122-128 is +Δ (because they are positioned further away from the heating element 140) then positioning the voltage compensating unit 150 on the opposite side of the Buried Zener diode 110 with respect to the transistors 122-128 generates a negative voltage (because the voltage compensating unit 150 is positioned closer to the heating element 140) that is substantially equal to the offset voltage, e.g., approximately −Δ. In other words, the transistors 122-128 are positioned on one side of the Buried Zener diode 110 (e.g., Buried Zener diode 110 encompasses the transistors 122-128) to generate a particular offset voltage, and as such positioning the voltage compensating unit 150 on the other side of the Buried Zener diode 110 (e.g., outside of the Buried Zener diode 110 but within the area encompassed by the heating element 140) generates a voltage (approximately equal to the offset voltage) but with a different polarity, thereby reducing the offset voltage to approximately 0V. Accordingly, the change in ambient temperature experienced by the transistors 122-128 is substantially opposite to a change in ambient temperature experienced by the voltage compensating unit 150. As such, the offset voltage is substantially removed from the reference voltage.

In this nonlimiting example, the Buried Zener diode 110 is positioned at a first distance, e.g., d₄₁, from the heating element 140. The sensing elements 132-138 are positioned at a second distance from the Buried Zener diode 110. In this example four sensing elements 132-138 are illustrated but the examples should not be construed as limited thereto. For example, one sensing element may be used or more than four sensing elements may be used. In this nonlimiting example, each sensing element may be positioned at a different distance from the Buried Zener diode 110. For example, the sensing element 132 may be positioned at d₁₄ distance from the Buried Zener diode 110 and at distance d₁₂ from the heating element 140, the sensing element 134 may be positioned at d₂₄ distance from the Buried Zener diode 110 and at distance d₂₂ from the heating element 140, the sensing element 136 may be positioned at d₃₄ distance from the Buried Zener diode 110 and at distance d₃₂ from the heating element 140, and the sensing element 138 may be positioned at d₄₄ distance from the Buried Zener diode 110 and at distance d₄₂ from the heating element 140. In one nonlimiting example, each sensing element is positioned between the Buried Zener diode 110 and the heating element 140 and within (or less than) a particular threshold, e.g., less than distance of the Buried Zener diode 110 to the heating element 140 (i.e. d₄₁), approximately 0, etc., from the Buried Zener diode 110. In one nonlimiting example, each sensing element may be positioned adjacent to the Buried Zener diode 110. In one nonlimiting example, d₁₄, d₂₄, d₃₄, and d₄₄ are equal to one another and d₁₂, d₂₂, d₃₂, and d₄₂ are equal to one another. The transistors 122-128 are positioned at d₄₃ distance from the heating element 140. In this example, transistors 122-128 are positioned at the same distance from the heating element 140 for illustrative purposes and should not be construed as limiting the scope of the examples. For example, the distance between transistors 122 to the heating element 140 may be different from the distance between the transistors 124 to the heating element 140, etc. As such, the distances of the sensing elements 132-138 to the Buried Zener diode 110 and to the heating element 140, the distances of the transistors 122-128 to the heating element 140, and the distance of the Buried Zener diode 110 to the heating element 140 are provided for illustrative purposes and should not be construed as limiting the scope of the examples.

Accordingly, in devices with a thermal gradient (e.g., with Buried Zener diode 110 due to its size), not all components experience a similar temperature (generated heat by the heating element 140). As such, a circuitry such as the transistors 122-128 that are used to generate a compensating voltage to address a change in ambient temperature results in an offset due to temperature mismatch between the temperature experienced by the sensing elements 132-138 and the transistors 122-128. The voltage compensating unit 150 is used to reduce the offset resulting from the temperature mismatch (due to the thermal gradient).

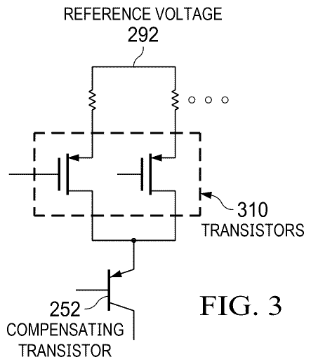

FIG. 2 is a schematic diagram of a circuit 200 associated with temperature drift compensation scheme, in an example. The circuit 200 includes a Buried Zener diode 210 (similar to that of FIG. 1) coupled to resistors 220 that is coupled to transistors 230 (similar to transistors 122-128 of FIG. 1) that generate the reference voltage with an offset, as described above. The voltage compensating unit 150 (as described in FIG. 1) may be used to reduce the amount of offset in order to generate a reference voltage 292. The voltage compensating unit 150 includes a programmable resistor 254 (described in greater detail in FIG. 3) and a compensating transistor 252 in order to output an offset voltage in opposite polarity than that generated by the transistors 230.

As described above, thermal gradient across the Buried Zener diode 210 results from changes in the ambient temperature as the heating element 140 power changes, thereby causing a temperature drift at the output (by the transistors 230) that introduces an offset voltage. The voltage compensating unit 150 (as described in FIG. 1 and FIG. 2) may be used to compensate for this offset voltage. In one nonlimiting example, a programmable resistor 254 may be used where it can be programmed to adjust the resistance value. Coupling the programmable resistor 254 to the compensating transistor 252 reduces the offset voltage to generate the reference voltage 292 (without the offset voltage or with minimal offset voltage). In other words, the changes of temperature (responsive to change in ambient temperature) experienced by transistors 230 is opposite to that of the compensating transistor 252.

According to one nonlimiting example, the changes of temperature in response to changes of the ambient temperature as experienced by the transistors 230 are PTAT and the temperature experienced by the transistors 230 reduces with respect to the ambient temperature because the transistors 230 are further away from the heating element 140 due to the large size of Buried Zener diode 210. In one nonlimiting example, the compensating transistor 252 provides a bias for transistors 230, and the Vdd is the buffer that provides the needed current (using a current control using a separate circuitry). The change of temperature as experienced by the compensating transistor 252 is complementary to absolute temperature (CTAT) and the temperature experienced by the compensating transistor 252 increases with respect to the ambient temperature (by being closer to the heating element 140 and being on the opposite side of the Buried Zener diode 210 than that of transistors 230 or transistors 122-128). In one nonlimiting example, the transistors 230 may be CTAT and the compensating transistor 252 may be PTAT. Accordingly, OCVR adds a current into the PTAT current generation loop in order to compensate for the temperature drift, thereby removing the offset voltage introduced by the transistors 230.

FIG. 3 is a schematic diagram of a programmable voltage compensating unit, in an example. In this nonlimiting example, a plurality of transistors 310 may be coupled to a plurality of resistors in parallel. The resistors may be referred to as trim resistors. In other words, each transistor may be coupled in series with its respective resistor and each combination of the transistor/resistor may be coupled to one another in parallel. As such, enabling/disabling individual transistors of the plurality of transistors 310 couples the respective resistor in parallel with the other resistors, thereby programming the resistance value. Changing the resistance value changes the amount of offset voltage that is being removed by the compensating transistor 252.

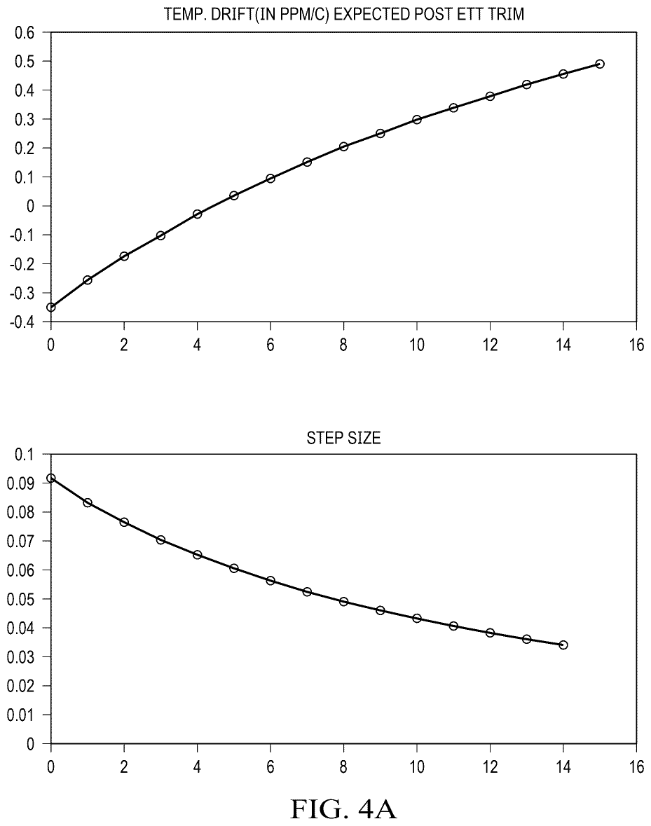

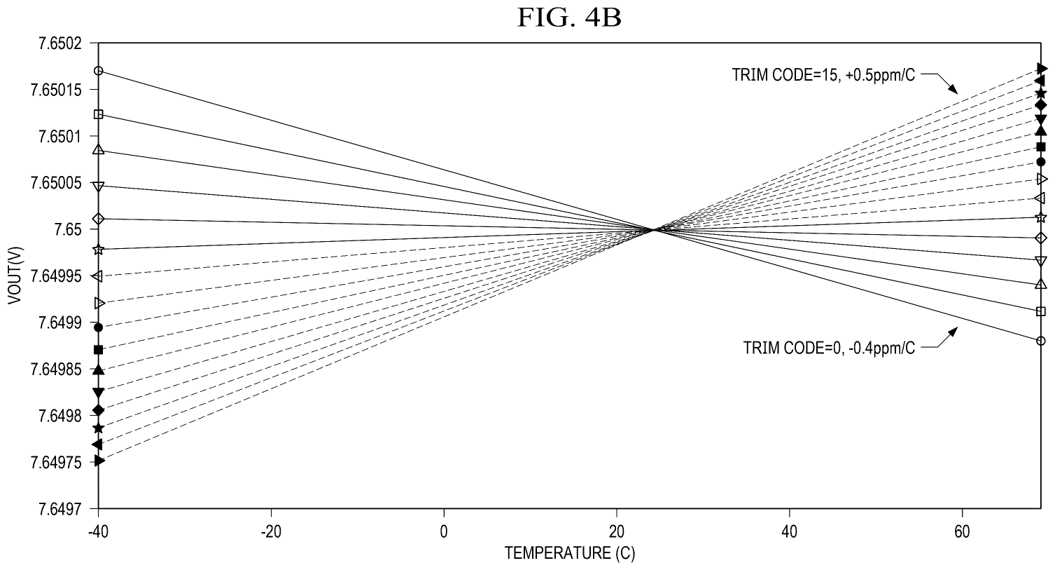

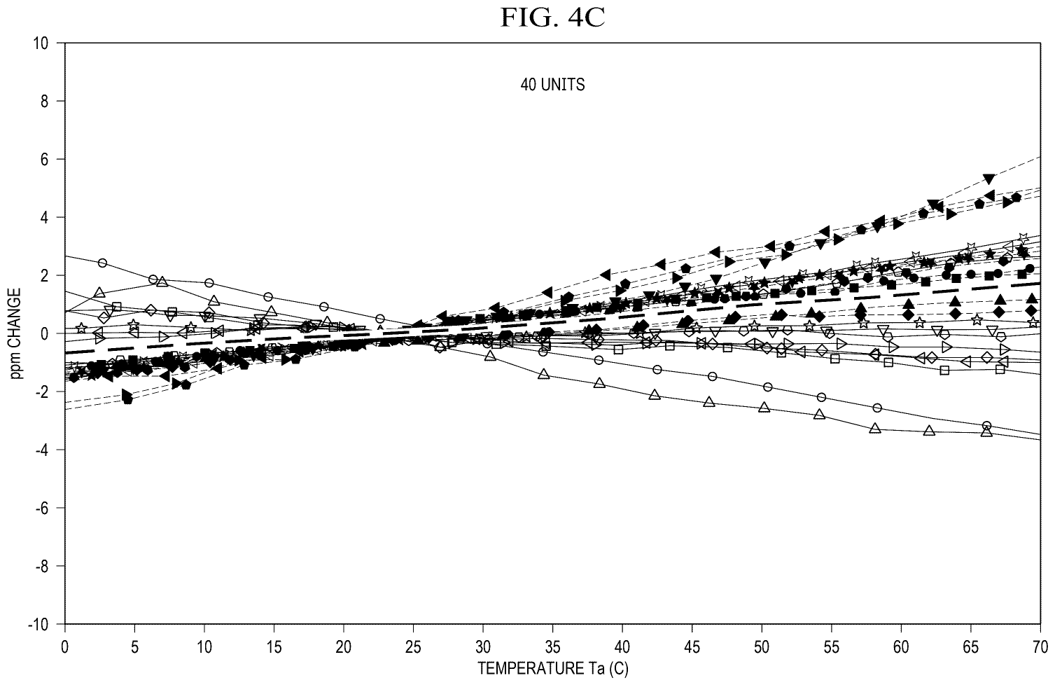

FIG. 4A shows the expected temperature drift after applying the voltage compensating unit in an example. As illustrated performance of less than 0.2 ppm/C may be achieved. In one nonlimiting example, the resistance value of the resistors 220 (or resistance of the transistors 230) may range between 37.5 Ω to 300 Ω which may be in series with the trim resistors 4400 Ω to 16.75 kΩ. In other words, the resistance of the resistors 220 is less than 2.5% of the trim resistors (resistors associated with transistors 310). FIG. 4B shows a simulation result for temperature drift with respect to trim code, in an example. FIG. 4C shows performance for a number of different temperature coefficients. As illustrated, the best performance is approximately 0.005 ppm/C and the worst performance is approximately 0.094 ppm/C whereas in the conventional system performance is approximately 1 ppm/C.

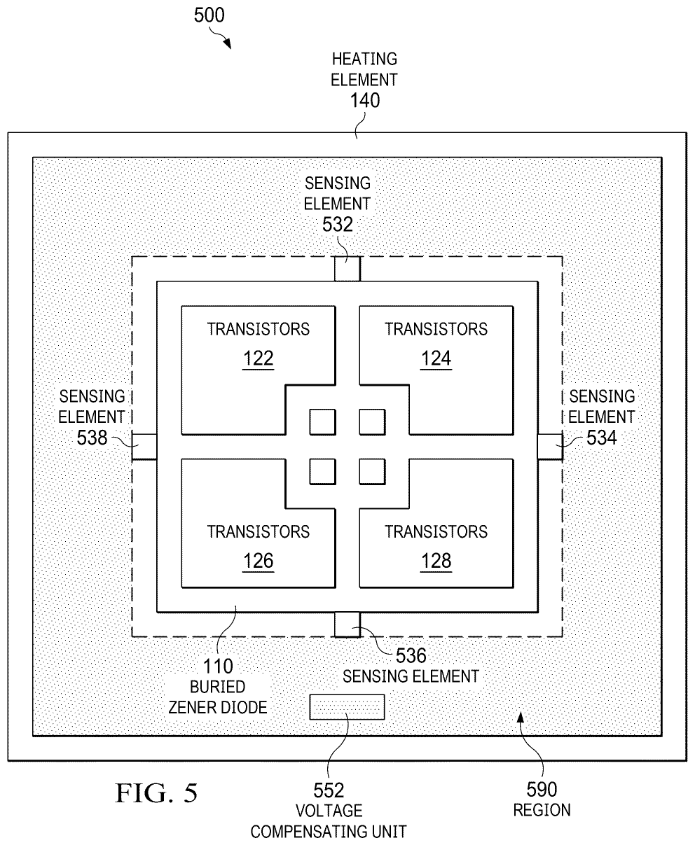

FIG. 5 is a schematic diagram of the device 500 including a voltage compensating unit of FIG. 1 and positioning of the voltage compensating unit, in an example. FIG. 5 is substantially similar to that of FIG. 1 with sensing elements 532-538 positioned adjacent to the Buried Zener diode 110. The sensing elements 532-538 are similar to that of FIG. 1. In this example, region 590 (shaded area) is illustrated to show the area in which the voltage compensating unit 552 can move around in and reduce the offset voltage associated with the transistors 122-128. The voltage compensating unit 552 operates substantially similar to the voltage compensating unit 150 of FIG. 1. As illustrated, the voltage compensating unit 552 is positioned in the area between the sensing elements and the heating element 140 in order to counteract the offset voltage of the transistors 122-128.

Particular positioning of components (e.g., heating element, Buried Zener diode, sensing elements, voltage compensating unit, and transistors), particular number of components (e.g., heating element, Buried Zener diode, sensing elements, voltage compensating unit, and transistors), particular shape of components (e.g., ring-shaped heating element, heating element encompassing other components, Buried Zener diode encompassing the transistors, etc.), etc., are provided for illustrative purposes and should not be construed as limiting the scope of the examples.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

Modifications are possible in the described embodiments, and other embodiments are possible, within the scope of the claims.

What is claimed is:

1. A device comprising:
a heating element configured to generate heat for a die and to maintain a temperature for the die;
a Buried Zener diode positioned at a first distance from the heating element, wherein current flows in the Buried Zener diode in response to the Buried Zener diode reaching a Zener voltage;
a sensing element positioned at a second distance to the Buried Zener diode, wherein the second distance is smaller than the first distance, and wherein a distance between a position of the Buried Zener diode and a position of the sensing element is less than a given threshold, wherein the sensing element is configured to sense a temperature of the die at the second distance from the Buried Zener diode and to control a heat generated by the heating element in response thereto;
at least one or more transistors associated with the Buried Zener diode configured to output a first voltage reference, wherein the first voltage reference is a reference voltage with an offset voltage, wherein the at least one or more transistors are positioned at a third distance from the heating element thereby positioning the Buried Zener diode between the heating element and the one or more transistors, wherein the third distance is greater than the first distance, and wherein the offset results from a change in ambient temperature between a location of the at least one or more transistors and a location of the sensing element; and
a voltage compensating unit positioned between the sensing element and the heating element, wherein the voltage compensating unit is configured to reduce the offset voltage.

2. The device of claim 1, wherein the change in ambient temperature seen by the at least one or more transistors is substantially opposite to a change in ambient temperature seen by the voltage compensating unit.

3. The device of claim 1, wherein the voltage compensating unit comprises a transistor coupled to a plurality of resistors, wherein the plurality of resistors is programmable to adjust a resistance value.

4. The device of claim 3, wherein resistors of the plurality of resistors are parallel to one another and wherein each resistor of the plurality of resistors is associated with a respective transistor that couples the each resistor with other resistors of the plurality of resistors when turned on.

5. The device of claim 3, wherein the change in ambient temperature seen by the transistor coupled to the plurality of resistors is complementary to absolute temperature (CTAT).

6. The device of claim 1, wherein the change in ambient temperature seen by the at least one or more transistors is proportional to absolute temperature (PTAT).

7. The device of claim 1, wherein the heating element is a heater ring that substantially enclose the Buried Zener diode, the sensing element, the at least one or more transistors, and the voltage compensating unit.

8. The device of claim 1, wherein a surface of the die occupied by the Buried Zener diode creates a thermal gradient across the die, and wherein the offset voltage results from the at least one or more transistors being at a different thermal gradient from the Buried Zener diode.

9. The device of claim 1, wherein the sensing element is a temperature sensor.

10. The device of claim 9, wherein the sensing element is positioned adjacent to the Buried Zener diode.

11. A device comprising:
a heating element configured to generate heat for a die and to maintain a temperature for the die;
a Buried Zener diode positioned at a first distance from the heating element;
a sensing element positioned at a second distance to the Buried Zener diode, wherein the second distance is smaller than the first distance, and wherein a distance between a position of the Buried Zener diode and a position of the sensing element is less than a given threshold, wherein the sensing element is configured to sense a temperature of the die at the second distance from the Buried Zener diode and to control a heat generated by the heating element in response thereto;
at least one or more transistors coupled to the Buried Zener diode configured to output a first voltage reference, wherein the first voltage reference is a reference voltage with an offset voltage, wherein the at least one or more transistors are positioned at a third distance from the heating element thereby positioning the Buried Zener diode between the heating element and the one or more transistors, wherein the third distance is greater than the first distance; and
a voltage compensating unit positioned between the Buried Zener diode and the heating element, wherein the voltage compensating unit is configured to reduce the offset voltage.

12. The device of claim 11, wherein a change in ambient temperature seen by the at least one or more transistors is substantially opposite to a change in ambient temperature seen by the voltage compensating unit.

13. The device of claim 11, wherein the voltage compensating unit comprises a transistor coupled to a plurality of resistors, wherein the plurality of resistors is programmable to adjust a resistance value.

14. The device of claim 13, wherein resistors of the plurality of resistors are parallel to one another and wherein each resistor of the plurality of resistors is associated with a respective transistor that couples the each resistor with other resistors of the plurality of resistors when turned on.

15. The device of claim 13, wherein a change in ambient temperature seen by the transistor coupled to the plurality of resistors is complementary to absolute temperature (CTAT).

16. The device of claim 11, wherein a change in ambient temperature seen by the at least one or more transistors is proportional to absolute temperature (PTAT).

17. The device of claim 11, wherein the heating element is a heater ring that substantially enclose the Buried Zener diode, the sensing element, the at least one or more transistors, and the voltage compensating unit.

18. The device of claim 11, wherein a surface of the die occupied by the Buried Zener diode creates a thermal gradient across the die, and wherein the offset voltage results from the at least one or more transistors being at a different thermal gradient from the Buried Zener diode.

19. The device of claim 11, wherein the sensing element is a temperature sensor.

20. The device of claim 19, wherein the sensing element is positioned adjacent to the Buried Zener diode.
